(19) United States
(12) Patent Application Publication
(10) Pub. No.: US 2018/0361944 A1
(43) Pub. Date: Dec. 20, 2018

(54) BICYCLE RACK SUPPORTED ON THE SIDEWALL OF A TRUCK BOX

(71) Applicant: FORD GLOBAL TECHNOLOGIES, LLC, Dearborn, MI (US)

(72) Inventors: Jack MARCHLEWSKI, Saline, MI (US); Joshua Robert HEMPHILL, White Lake, MI (US); Robert REINERS, Grosse Ile, MI (US); Dragan B. STOJKOVIC, Taylor, MI (US); Jeffrey GRAY, Dearborn, MI (US)

(21) Appl. No.: 15/627,622

(22) Filed: Jun. 20, 2017

(51) Int. Cl. B60R 9/10; B60R 9/06; B62D 33/02

(52) U.S. Cl. CPC B60R 9/10; B62D 33/0207; B60R 9/06

(57) ABSTRACT

A bicycle rack is attached to a pickup truck having a plurality of receptacles in sidewalls of a truck box spaced above a truck bed. The bicycle rack comprises a bicycle receiver attached to a set of arms. A pair of connectors are attached to the arms to detachably assemble the arms to the receptacles with the arms and the receiver being held in a position spaced from the bed. A method is disclosed for transporting a bicycle with a pickup truck by providing connectors attached to the arms that are detachably assembled to the receptacles by sliding the connectors downwardly relative to the receptacles. The bicycle and bicycle rack do not require support from the truck bed and do not obstruct the truck bed.

### TECHNICAL FIELD

The disclosure relates to a bicycle rack that is attached to a receptacle in the sidewall of a pickup truck box without requiring additional supporting structure connected to the truck bed.

### BACKGROUND

Pickup trucks are versatile vehicles that are well adapted to transport a wide variety of types of cargo for work or recreation. Bicycles are relatively long and have handle bars that prevent them from being closely stacked side-by-side. Several different devices have been proposed for transporting bicycles in the bed of a pickup truck but they generally obstruct the bed and limit the space available in the bed for other types of cargo. One example of such a bicycle rack is disclosed in U.S. Pat. No. 8,820,811 that is assigned to the assignee of this application.

This disclosure is directed to solving the above problems and other problems as summarized below.

### SUMMARY

According to one aspect of this disclosure, a bicycle rack is disclosed that is attached to a pickup truck having a plurality of receptacles in the sidewalls of a truck box. The bicycle rack is spaced above a truck bed and does not require support from or obstruct the truck bed. The bicycle rack comprises a bicycle receiver attached to a set of arms. A pair of connectors are attached to the arms to detachably assemble the arms to the receptacles with the arms and the receiver spaced from the bed.

The receptacles have load supporting portions that the connectors are assembled to by sliding the connectors onto the supporting portions. The connectors are retained on the receptacles by a locking cam that engages the supporting portions.

The receptacles may define an opening having a lower supporting edge and an upper supporting edge. The connectors may further comprise a tab offset from a plate portion of the connector that may be received in the opening above the lower supporting edge with the plate portion abutting an outer face of the receptacles. A hook may be provided on a top end of the plate portion that receives the upper supporting edge of the receptacle.

The bicycle receiver may be an upwardly open channel that is adapted to receive the tires or other parts of the bicycle.

The bicycle rack may include a pair of arms that extend vertically above the connectors inside the sidewall and include an upper portion that is disposed above an upper surface of the sidewall. The bicycle receiver is attached to the upper portion and allows the bicycle to be carried entirely outside the truck bed.

In other alternative arrangements, the pair of arms may include a body portion and a leg portion that is disposed at an angle to the body portion to extend inwardly and into the truck box. The bicycle receiver is attached to the leg portion and holds the bicycle spaced above the truck bed. The leg portion may extend from a lower end of the body portion or may extend from an upper end of the body portion. The body portion may be adapted to abut an outer face of the receptacles.

According to another aspect of this disclosure, a method is disclosed for transporting a bicycle with a pickup truck including sidewalls having receptacles and a truck bed between the sidewalls. The method comprises providing a rack including arms supporting a bicycle receiver that a bicycle is secured to be transported. Connectors are attached to the arms that are detachably assembled to the receptacles. The arms and the receiver are spaced above the bed and are assembled by sliding the connectors downwardly relative to the receptacles.

The connectors are retained on the receptacles by rotating a locking cam disposed on the rack to lock the connectors to the receptacles. The locking cam wedges against the top portion of the opening defined by the receptacle to positively hold the tab against the lower supporting edge of the opening.

The above aspects of this disclosure and other aspects will be described below with reference to the attached drawings.

### BRIEF DESCRIPTION OF THE DRAWINGS

FIG. 1 is a side elevation view of a pickup truck transporting a bicycle utilizing a rack made according to one embodiment of this disclosure.

FIG. 2 is a fragmentary partially exploded perspective view of a pickup truck box with a rack made according to one embodiment of this disclosure.

FIG. 3 is an elevation view of a receptacle that is attached to a sidewall of a pickup truck box.

FIG. 4 is a right rear perspective view of a pickup truck shown with a bicycle rack attached to a sidewall that is made according to another embodiment of this disclosure.

FIG. 5 is a top plan view of the pickup truck and bicycle rack shown in FIG. 4.

FIG. 6 is a right rear perspective view of a pickup truck shown with a bicycle rack attached to a sidewall that is made according to an over the top of the sidewall embodiment of this disclosure.

FIG. 7 is a fragmentary cross-sectional view taken along the line 7-7 in FIG. 6.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

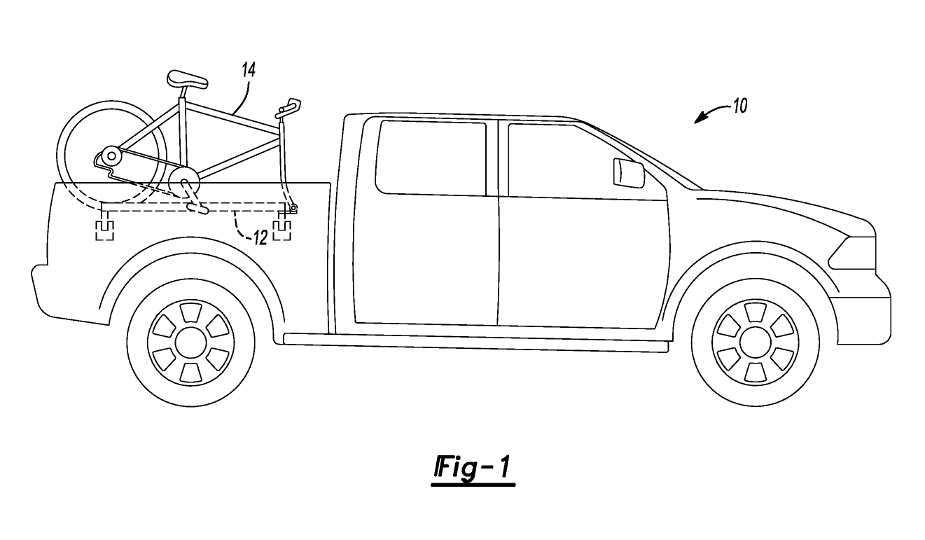

Referring to FIG. 1, a pickup truck 10 is shown with a bicycle rack 12 carrying a bicycle 14.

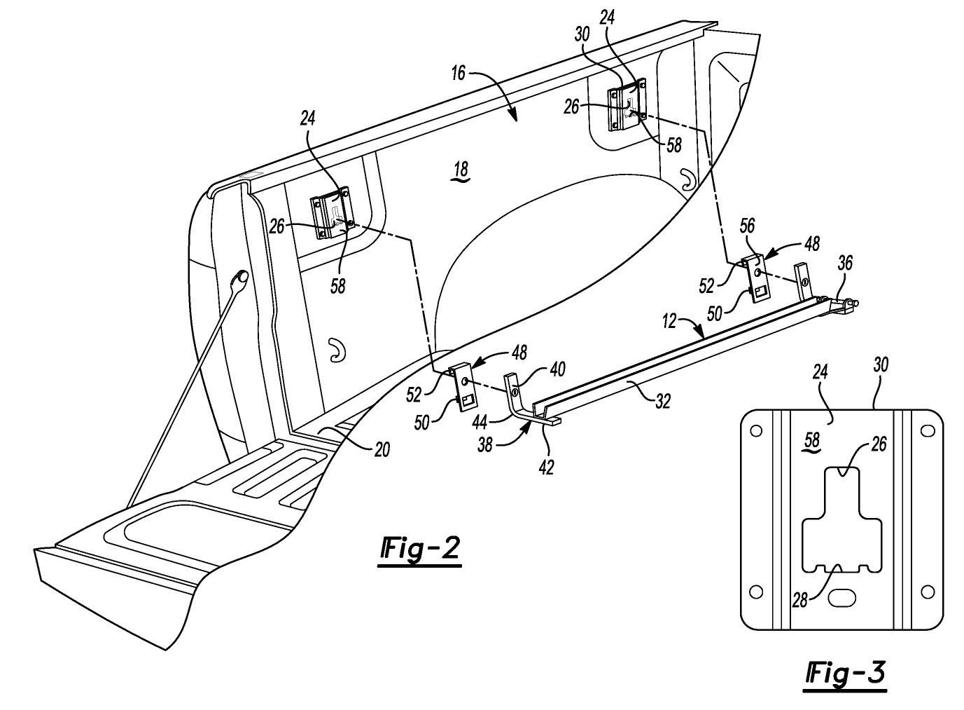

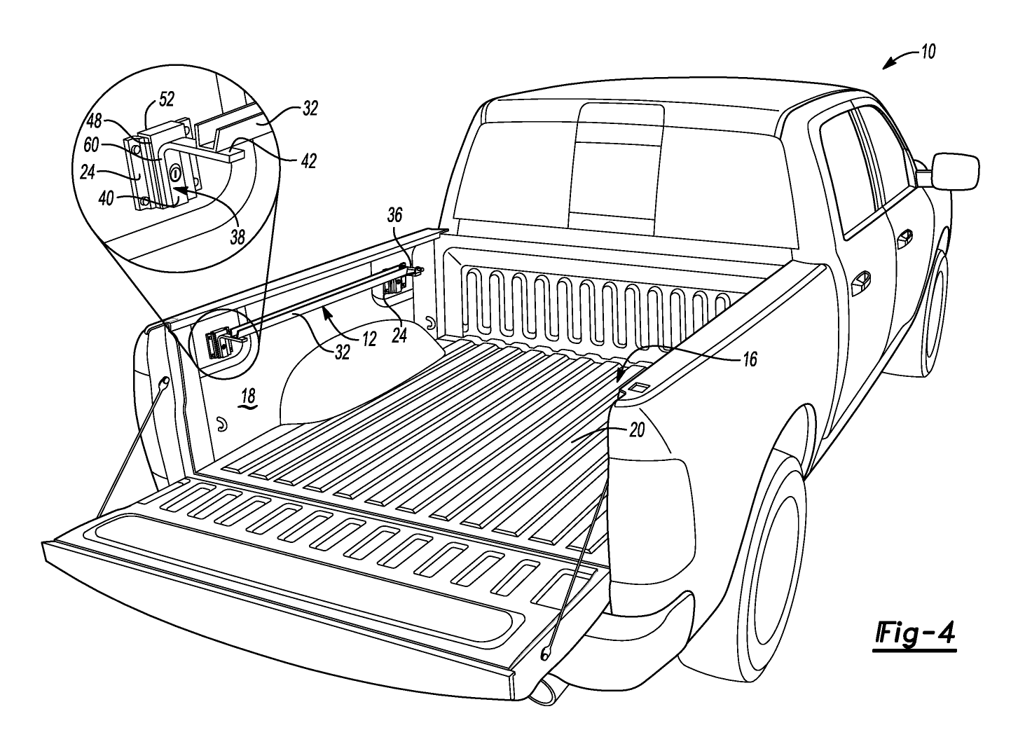

Referring to FIGS. 2 and 3, a truck box 16 of the pickup truck 10 shown in FIG. 1, is partially illustrated with a bicycle rack 12 shown detached from a sidewall 18 of the truck box 16. Two sidewalls 18 are provided on opposite sides of a truck bed 20. The sidewalls 18 include a pair of receptacles 24 that define an opening 26. The receptacles 24 have supporting edges that support the bicycle rack 12. A lower supporting edge 28 is provided in the opening 26 and an upper supporting edge 30 is provided on the top of the receptacles 24.

The bicycle rack 12 includes a receiver 32, or channel, in which the bicycle 14 is assembled to be carried by the pickup truck. A lock pin assembly 36 is provided on one or both ends of the receiver 32 that is used to lock the bicycle 14 in the receiver 32. The bicycle rack 12 includes arms 38 that are connected to the receiver 32. The arms 38 include a body portion 40 and a leg 42. The leg 42 extends from a lower end 44 of the body portion 40.

A connector 48 is shown exploded away from the body portion 40 of the arms 38. The connector 48 includes a tab 50 and a hook 52. The hook 52 is formed on the top end 54 of a plate portion 56. The tab 50 is formed in the plate portion 56. The plate portion 56 is assembled to an outer face 58 of the receptacle 24 with the tab 50 being assembled to the lower supporting edge 28 of the opening 26. The hook 52 is hooked over the upper supporting edge 30 of the receptacle 24. A cam lock 59 may be provided on the bicycle rack 12 that extends through the body portion 40 and connector 48. The cam lock 59 is inserted into the opening 26 to selectively prevent the connector 48 from sliding upwardly and detaching the bicycle rack 12 from the receptacle 24.

Referring to FIG. 3, a receptacle 24 is shown to define the opening 26. The lower supporting edge 28 defines the lower end of the opening 26. The upper supporting edge 30 is also the upper edge of the receptacle 24. The opening 26 is formed through the outer face 58 of the receptacle 24.

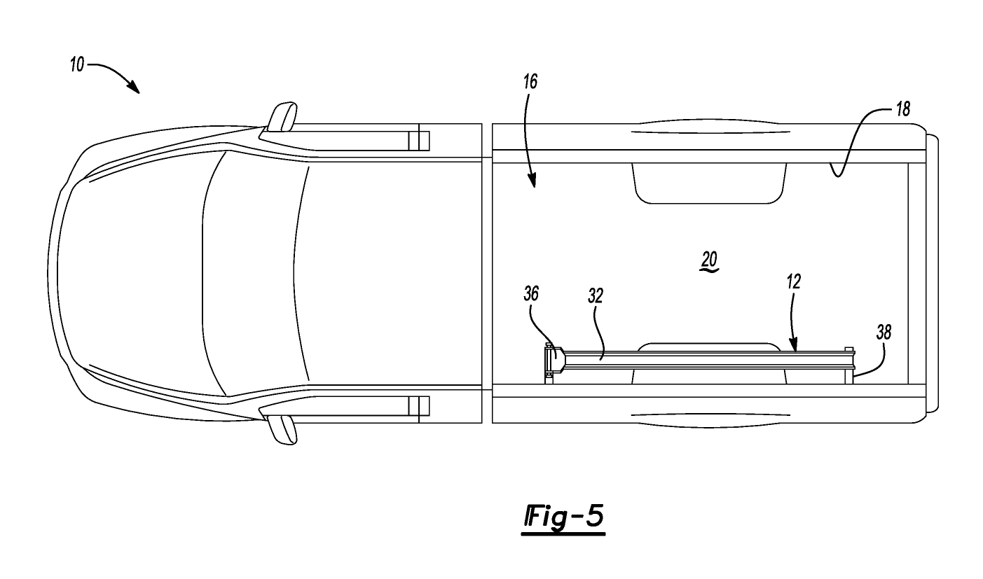

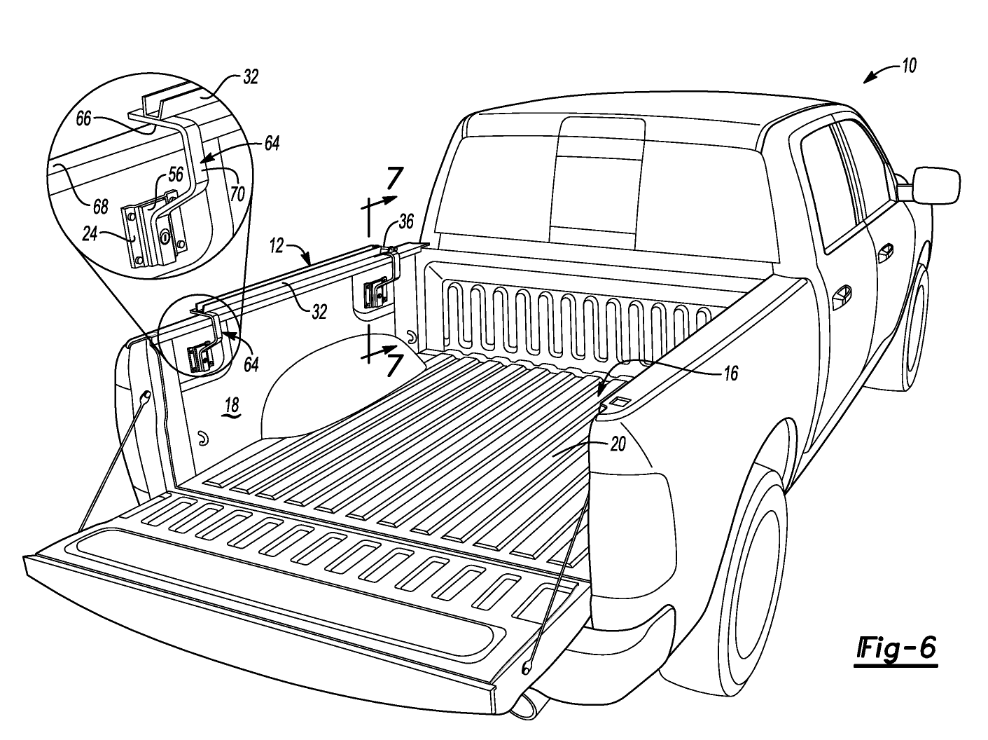

Alternative embodiments of the bicycle rack 12 are shown in FIGS. 4-7. For brevity, portions of the bicycle rack 12 shown in FIGS. 4-7 that are similar to the embodiment of FIGS. 2 and 3 use the same reference numerals to refer to corresponding elements of the different embodiments.

The bicycle rack 12 is shown attached to the receptacles 24. Arms 38 are shown supporting the bicycle receiver 32, or channel, that is adapted to receive the bicycle 14. The receptacles 24 are attached to the sidewall 18. Body portions 40 of the arms 38 are attached to the connector 48 and may be selectively locked together by the cam lock 59. As previously described with reference to FIGS. 2 and 3, legs 42 support the bicycle receiver 32. The legs 42 extend from the body portions 40 at the upper end 60 of the body portions 40. The bicycle receiver 32 is disposed inside the truck box 16 in a spaced relationship relative to the truck bed 20. The bicycle rack 12 does not require any supporting support other than the receptacles 24 and the sidewalls 18 and leaves the entire truck bed 20 unencumbered by any portion of the bicycle rack 12.

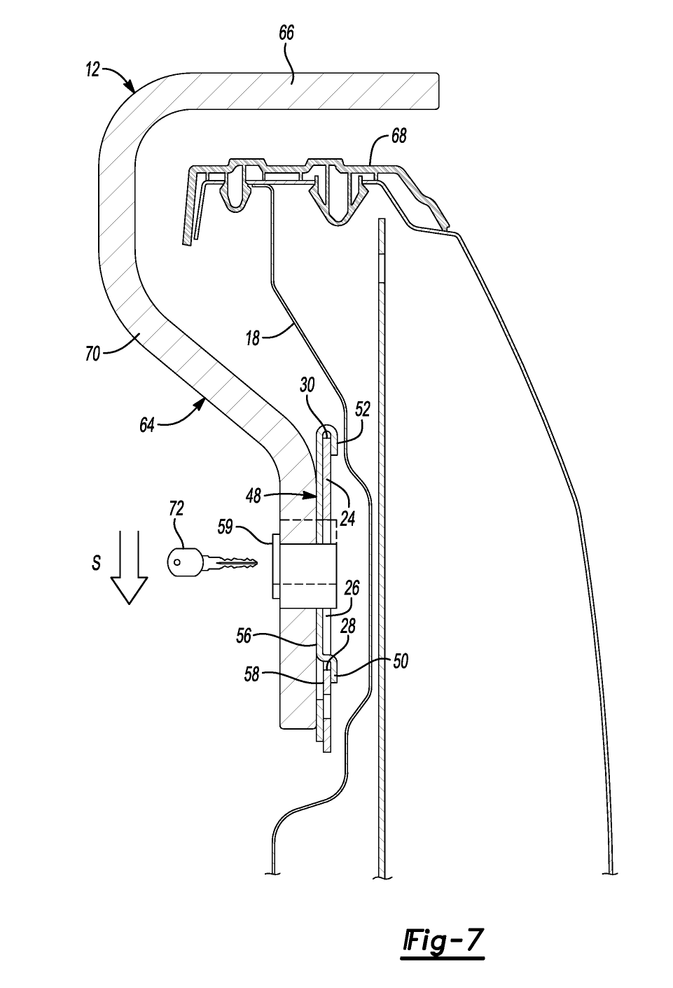

Referring to FIGS. 6 and 7, another alternative embodiment of the bicycle rack 12 is shown that is attached to the sidewalls 18 of the pickup truck 10. In this embodiment, the bicycle 14 (shown in FIG. 1) is carried above the truck box 16 in a spaced relationship relative to the truck bed 20. The arms, generally indicated by reference numeral 64, include an upper portion 66 and is disposed above an upper surface 68 of the sidewalls 18. The upper portion 66 of the arms 64 is held in a spaced relationship relative to the upper surface 68 of the truck box 16. The upper portion 66 of each arm 64 is supported on a riser 70, or body, that forms a hook in combination with the upper portion 66. The arms 64 are attached to the receptacles 24 through a plate portion 56. The receiver 32 (shown in FIG. 2) is attached to the upper portion 66 of the arm 64.

Referring specifically to FIG. 7, the arm 64 is shown as it is attached to the receptacle 24 through the plate portion 56 of the connector 48. The plate portion 56 is provided with the tab 50 at an intermediate location on the plate portion 56. The tab 50 is inserted into and connected to the lower supporting edge 28 of the opening 26 defined by the receptacle 24. The cam lock 59 is also inserted into the opening 26 defined by the receptacle 24 and turned to a position shown in dashed lines engaging an upper portion of the opening 26 to prevent the tab 50 from disengaging the lower supporting edge 28. The hook 52 is formed on the plate portion 56 and is received on the upper supporting edge 30 of the receptacle 24.

The tab 50 and hook 52 are secured to the receptacle 24 by sliding the plate portion 56 against the outer face 58 of the receptacle 24 in the direction indicated by arrow “S.” The cam lock 59 is rotated to engage the top portion of the opening 26 to hold the bicycle rack 12 in place on the receptacle 24. He locking cam 59 may be a lock cylinder that is operated by a key 72 that may be provided to lock and unlock the locking cam 59 to secure the bicycle rack to the receptacles 24. The bicycle is held above the truck box and is spaced from the truck bed and does not encumber the truck bed 20 in any way.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

What is claimed is:

1. A bicycle rack attached to a pickup truck having a plurality of receptacles in sidewalls of a truck box spaced above a truck bed, the bicycle rack comprising:
a bicycle receiver adapted to have a bicycle attached thereto;
a pair of arms supporting the bicycle receiver; and
a pair of connectors attached to the arms that are detachably assembled to the receptacles, wherein the bicycle rack is spaced from the bed.

2. The bicycle rack of claim 1 wherein the receptacles have load supporting portions, wherein the connectors are assembled to the load supporting portions with the bicycle rack being retained by a locking cam that engages the supporting portions.

3. The bicycle rack of claim 1 wherein the receptacles define an opening having a lower supporting edge, and wherein the receptacles have an upper supporting edge, the connectors further comprise:
a tab offset from a plate portion of the connector, the tab being received in the opening above the lower supporting edge and the plate portion abutting an outer face of the receptacles; and
a hook provided on a top end of the plate portion that receives the upper supporting edge of the receptacle.

4. The bicycle rack of claim 3 wherein the plate portion abuts an outer face of the receptacles.

5. The bicycle rack of claim 1 wherein the bicycle receiver is an upwardly open channel that is adapted to receive the bicycle.

6. The bicycle rack of claim 1 wherein the pair of arms extend vertically above the connectors inside the sidewall and include an upper portion that is disposed above an upper surface of the sidewall, and wherein the bicycle receiver is attached to the upper portion to carry the bicycle entirely outside the truck bed.

7. The bicycle rack of claim 1 wherein the pair of arms include a body portion and a leg portion, wherein the leg portion is disposed at an angle to the body portion to extend inwardly into the truck box, and wherein the bicycle receiver is attached to the leg portion to hold the bicycle spaced above the truck bed.

8. The bicycle rack of claim 7 wherein the leg portion extends from a lower end of the body portion.

9. The bicycle rack of claim 7 wherein the leg portion extends from an upper end of the body portion.

10. A method of transporting a bicycle with a pickup truck including sidewalls having receptacles and a truck bed between the sidewalls, the method comprising:
providing a rack including arms supporting a receiver, and connectors attached to the arms and detachably assembled to the receptacles, wherein the arms and the receiver are spaced above the bed;
engaging the receptacles by sliding the connectors downwardly relative to the receptacles; and
attaching the bicycle to the receiver.

11. The method of claim 10 wherein the receptacles have load supporting portions, the method further comprising:
sliding the connectors relative to the receptacles;
retaining the rack and the bicycle on the load supporting portions of the receptacles; and
rotating a locking cam disposed on the rack to lock the connectors to the receptacles.

12. The method of claim 10 wherein the receptacles define an opening having a lower supporting edge, and an upper supporting edge, the method further comprising:
inserting a tab offset from a plate portion of the connector into the opening above the lower supporting edge with the plate portion abutting an outer face of the receptacles; and
assembling a hook provided on a top end of the plate portion over the upper supporting edge of the receptacle.

13. The method of claim 10 wherein the arms have riser portions extending vertically above the connectors inboard of the sidewall and include an upper portion that is disposed above an upper surface of the sidewall, and wherein the receiver is attached to the upper portion, the method further comprising:
carrying the bicycle entirely outside the truck bed.

14. The method of claim 10 wherein the arms include a body portion and a leg portion, wherein the leg portion is disposed at an angle to the body portion to extend inwardly and above the truck bed, and wherein the receiver is attached to the leg portion, the method further comprising:
holding the bicycle spaced above the truck bed.
